(19) United States
(12) Patent Application Publication
(10) Pub. No.: US 2023/0283153 A1
(43) Pub. Date: Sep. 7, 2023

(54) CONDUCTOR END SHAPING METHOD AND DEVICE

(71) Applicant: GROB-WERKE GmbH & Co. KG, MINDELHEIM (DE)

(72) Inventors: Tobias WEGSCHEIDER, Mindelheim (DE); Oliver BITTNER, Mindelheim (DE); Tomislav JELEN, Augsburg (DE); Frederik SCHMID, Illertissen (DE); Johannes HEIDE, Jettingen (DE); Thomas THURNHUBER, Günz (DE)

(21) Appl. No.: 18/177,366

(22) Filed: Mar. 2, 2023

(30) Foreign Application Priority Data
Mar. 4, 2022 (DE) 102022105168.4
Jun. 30, 2022 (EP) 22182228.1

(51) Int. Cl. H02K 15/00

(52) U.S. Cl. CPC H02K 15/0031

(57) ABSTRACT

A method and a device by which conductor ends of hairpins sticking out from stator slots are shaped to form coil windings. The ends are shaped in the radial direction using different widening tools allowing the ends to be engaged individually or in pairs so that a first part is at a first radial position, a second part is at a second radial position and a third part is at at least one intermediate position in between. Subsequently, the ends are shaped in the circumferential direction using twisting tools, wherein a twisting tool located further out has inwardly open inner receiving pockets, and a twisting tool located further in has outwardly open outer receiving pockets. At least one of the twisting tools has both inner and outer receiving pockets, one of these located at the at least one intermediate position to shape the third part of the ends.

### CROSS-REFERENCES TO RELATED APPLICATIONS

This application claims the benefit of German Patent Application No. 102022105168.4, filed on Mar. 4, 2022, and European Patent Application No. 22182228.1 filed on Jun. 30, 2022, the entire disclosures of which are incorporated herein by way of reference.

### FIELD OF THE INVENTION

The invention relates to a conductor end shaping method for shaping conductor ends sticking out in an axial direction from an arrangement of stator slots of a stator component extending annularly around a central axis to form a stator of an electric machine. The invention further relates to a conductor end shaping device for shaping conductor ends sticking out in the axial direction from an arrangement of stator slots of a stator component extending annularly around a central axis for forming a stator of an electrical machine.

### BACKGROUND OF THE INVENTION

For the technological background, reference is made to the following literature:
[1] WO 2019/161832 A1;
[2] WO 2019/161846 A1;
[3] WO 2020/127718 A1;
[4] DE 10 2018 103 930 A1;
[5] EP 3 907 864 A1;
[6] WO2019/114870 A1;
[7] WO 2018/233774 A1;
[8] WO 2019/007459 A1;
[9] WO 2021/026576 A1;
[10] WO 2019/201731 A1; and,
[11] DE 10 2019 219 481 A1.

Electrical machines are understood in particular to mean machines for converting electrical energy into kinetic energy and machines for converting kinetic energy into electrical energy. In particular, they are understood to include electric motors and generators.

In some methods of manufacturing stators of such electrical machines, ends of conductors formed from wires are connected with each other or otherwise processed together, such as cut or shaped together.

For example, there are electric motors in which coil windings, especially of the stator, are formed from different pieces of wire, the ends of which are then connected with each other. In particular, devices and methods for connecting conductor ends, usually wire ends, in the form of so-called “hairpins” (for example, conductor pieces bent in the shape of hairpins) to form stator windings of electrical machines are known, in which the conductor ends (also called “pins”) are welded together. Here, devices and methods are provided for positioning and clamping the conductor ends before welding.

In order to be able to weld the wire ends correctly, it is advantageous to first shape, in particular widen and twist, the wire ends sticking out from the individual slots of the housing of the component, for example after the insertion of hairpins or the like, in order to form pairs of wire ends to be joined together.

From documents [1] to [3], methods and devices for twisting (shaping the conductor ends in the circumferential direction with respect to the center axis of the component) are known. Before twisting, the conductor ends are often widened (i.e. shaped in the radial direction). Methods and devices for widening are known from documents [4] and [5] as well as [9] to [11]. Accordingly, it is known to use grippers or also other widening devices as widening tools.

The invention is based on the problem of providing methods and devices for shaping conductor ends for a more flexible and yet more process-reliable production of stators.

### SUMMARY OF THE INVENTION

To solve this problem, the invention provides a conductor end shaping method, and a conductor end shaping device. A computer program with instructions for carrying out the conductor end shaping process is also proposed.

In accordance with a first aspect thereof, the invention provides a conductor end shaping method for shaping conductor ends sticking out in an axial direction from an arrangement of stator slots of a stator component extending annularly about a central axis to form a stator of an electrical machine. The conductor end shaping method comprises the steps of:
a) widening the conductor ends by bending the conductor ends in a radial direction using several widening tools, such as grippers or also other widening tools, of a radial bending device so that, as a result of widening, a first part of the conductor ends is situated at a first radial position and a second part of the conductor ends is situated at a second radial position, and
b) twisting the conductor ends by bending in the circumferential direction using a circumferential bending device which has a first bending unit rotatable in a first direction of rotation and having a first annular arrangement of receiving pockets and a second bending unit rotatable in the second direction of rotation and having a second annular arrangement of receiving pockets arranged concentrically thereto.

Step b) comprises the steps of:
b1) inserting the first part of the conductor ends widened to the first radial position in step a) into the first arrangement of receiving pockets, inserting the second part of the conductor ends widened to the second radial position in step a) into the second arrangement of receiving pockets, and
b2) oppositely rotating the first and second bending units to bend the first part of the conductor ends and the second part of the conductor ends in opposite circumferential directions.

According to the invention, step a) comprises the step of:
a1) engaging at least one single conductor end by at least a first widening tool, such as a first gripper, to bend the thus engaged at least one single conductor end individually in the radial direction, and jointly engaging at least one pair of radially adjacent conductor ends by at least a second widening tool, such as a second gripper, to bend the pair of radially adjacent conductor ends together in the radial direction, wherein step a1) is performed such that a third part of the conductor ends is situated at at least one intermediate radial position between the first and second radial positions.

According to the invention, step b) comprises:
b0) providing the first and second bending units in such a way that the bending unit that is located radially further out has radially inner receiving pockets which are open towards the radially inner side, and the bending unit that is located radially further in has radially outer receiving pockets which are open towards the radially outer side, wherein a part of the receiving pockets of the first arrangement is located at the first radial position and another part of the receiving pockets of the first arrangement is radially offset thereto and situated at an intermediate radial position and/or a part of the receiving pockets of the second arrangement is located at the second radial position and another part of the receiving pockets of the second arrangement is radially offset thereto and located at an intermediate radial position.

According to the invention, step b1) comprises:
b1a) inserting conductor ends widened to the at least one intermediate radial position into a respective receiving pocket of the other part of the first or second arrangement and inserting a respective radially inner conductor end of each pair of conductor ends jointly bent in step a1) into one of the radially outer receiving pockets and the radially outer conductor end of the pair into one of the radially inner receiving pockets.

Preferably, step a) comprises the step of:
a0) providing a separate radial bending control data set for each individual conductor end to be radially bent or each pair of conductor ends to be jointly bent and individually controlling the respective widening tool, such as the respective gripper, by means of the radial bending control data set assigned to the conductor end to be bent.

Preferably, step a) comprises the step of:
a2) simultaneously using different widening tools from the group of widening tools comprising a single widening tool for engaging a single conductor end, a conductor end pair widening tool for engaging a pair of conductor ends, and a combination widening tool formed at different engaging sections and configured for engaging a single conductor end and for engaging a pair of conductor ends.

Preferably, step a) comprises the step of:
a2a) simultaneously using different grippers from the group of grippers as widening tools, the grippers comprising a single gripper for gripping a single conductor end, a conductor end pair gripper for gripping a pair of conductor ends, and a combination gripper formed at different gripping sections for gripping a single conductor end and for gripping a pair of conductor ends.

Preferably, step a) comprises the step of:
a3) simultaneously engaging, by said widening tools, multiple conductor ends sticking out at the same radial position from the stator slots and releasing individual or pairs of the conductor ends thus engaged after a differential movement in the radial direction so as to bend the first part to the first radial position, the third part to the at least one intermediate radial position and the second part to the second radial position.

Preferably, step a0 comprises the step of:
a0a) generating the radial bending control data sets corresponding to a desired winding scheme for the stator to be manufactured.

Preferably, step a0) comprises the step of:
a0b) generating a master control data set for a conductor end or a pair of conductor ends to be equally bent to form a group of conductor ends or pairs of conductor ends and generating the additional control data sets of the group of conductor ends or pairs of conductor ends to be equally bent while copying the master control data set.

Preferably, step a0) comprises the step of:
a0c) parameterizing the nominal position and the radial bending movement for each conductor end to generate the radial bending control data set.

Preferably, step b0) comprises the step of:
b01) providing, as a first bending unit, a first twisting crown having an annular wall, at the axial end of which the first arrangement of receiving pockets is formed, wherein radially inner receiving pockets are formed by inner grooves formed radially inwards and open at the axial end and radially outer receiving pockets are formed by outer grooves formed radially outwards and open at the axial end.

Preferably, step b0) comprises the step of:
b02) providing, as a second bending unit, a second twisting crown having an annular wall, at the axial end of which the second arrangement of receiving pockets is formed, wherein radially inner receiving pockets are formed by inner grooves formed radially inwards and open at the axial end and radially outer receiving pockets are formed by outer grooves formed radially outwards and open at the axial end.

In preferred embodiments, at least one of the twisting crowns is formed with inner and outer receiving pockets. Depending on the design and arrangement, the inner or the outer receiving pockets can be located at the least one intermediate radial position.

According to another aspect, the invention provides a conductor end shaping device for shaping conductor ends sticking out in an axial direction from an arrangement of stator slots of a stator component extending annularly about a central axis to form a stator of an electrical machine, the device comprising:
a radial bending device for widening the conductor ends using a plurality of widening tools such as grippers, which widening tools are designed for bending the conductor ends in the radial direction in such a way that, after bending, a first part of the conductor ends is situated at a first radial position and a second part of the conductor ends is situated at a second radial position,
a circumferential bending device for twisting the conductor ends by bending in the circumferential direction, the circumferential bending device comprising a first bending unit rotatable in a first direction of rotation and having a first annular arrangement of receiving pockets and a second bending unit arranged concentrically thereto and rotatable in the second direction of rotation and having a second annular arrangement of receiving pockets,
and a controller adapted to control the conductor end shaping device to
a) widen the conductor ends by bending the conductor ends in a radial direction by means of the plurality of widening tools (e.g. grippers) of the radial bending device so that, as a result of said widening, a first part of the conductor ends is situated at a first radial position and a second part of the conductor ends is situated at a second radial position, and
b) twist the conductor ends by bending them in the circumferential direction using the circumferential bending device by
b1) inserting the first part of the conductor ends widened to the first radial position in step a) into the first arrangement of receiving pockets, inserting the second part of the conductor ends widened to the second radial position in step a) into the second arrangement of receiving pockets, and
b2) oppositely rotating the first and second bending units to bend the first part of the conductor ends and the second part of the conductor ends in opposite circumferential directions.

According to the invention, it is further provided that of the first and second bending devices, that bending unit which is located radially further out has radially inner receiving pockets which are open towards the radially inner side, and that bending unit which is located radially further in has radially outer receiving pockets which are open towards the radially outer side, wherein a part of the receiving pockets of the first arrangement is located at the first radial position and another part of the receiving pockets of the first arrangement is radially offset thereto and is located at an intermediate radial position and/or a part of the receiving pockets of the second arrangement is located at the second radial position and another part of the receiving pockets of the second arrangement is radially offset thereto and is located at an intermediate radial position.

According to the invention, the controller is further adapted to control the conductor end shaping device during the widening process according to step a) for the purpose of

a1) engaging at least a single conductor end by at least a first widening tool, such as a first gripper, in order to bend the conductor end thus gripped individually in the radial direction, and jointly engaging at least one pair of radially adjacent conductor ends by at least a second widening tool, such as a second gripper, in order to jointly bend the pair of radially adjacent conductor ends in the radial direction, the controller being adapted to perform control of the grippers in such a manner that a third part of the conductor ends is situated at at least one intermediate radial position between the first and second radial positions.

According to the invention, the controller is further adapted to control the conductor end shaping device during the insertion according to step b1) to

b1a) insert conductor ends widened to the at least one intermediate radial position into a respective receiving pocket of the other part of the first or second arrangement and insert a respective radially inner conductor end of each pair of conductor ends jointly bent in step a1) into one of the radially outer receiving pockets and the radially outer conductor end of the pair into one of the radially inner receiving pockets.

It is preferred that the controller is adapted to control the widening tools, such as grippers, of the radial bending device individually on the basis of individual dedicated radial bending control data sets for each individual conductor end to be radially bent or each pair of conductor ends to be bent together.

It is preferred that the radial bending device includes different widening tools from the group of widening tools comprising a single widening tool for engaging a single conductor end, a conductor end pair widening tool for engaging a pair of conductor ends, and a combination widening tool formed at different engaging sections for engaging a single conductor end and for engaging a pair of conductor ends.

It is preferred that the radial bending device has different grippers from the group of grippers as widening tools, the grippers comprising a single gripper for gripping a single conductor end, a conductor end pair gripper for gripping a pair of conductor ends, and a combination gripper formed at different gripping sections and configured for gripping a single conductor end and for gripping a pair of conductor ends.

It is preferred that the radial bending device has, as widening tools, grippers with a first gripping jaw and a second gripping jaw which can be moved towards each other for gripping and away from each other for releasing, wherein a receiving groove for the conductor end or ends to be gripped is formed on at least one of the gripping jaws between two shoulders, which receiving groove is designed to engage around a single conductor end in the case of a single gripper and to engage around the pair of conductor ends in the case of conductor end pair grippers.

It is preferred that the radial bending device has a combination gripper with different gripping sections, one of which is designed to grip a single conductor and another to grip a pair of conductor ends.

It is preferred that the controller is further adapted to control the radial bending device for simultaneously gripping, with the widening tools, a plurality of conductor ends sticking out at the same radial position from the stator slots and releasing individual or pairs of the conductor ends thus gripped after a differential movement in the radial direction, so as to bend the first part to the first radial position, the third part to the at least one intermediate radial position and the second part to the second radial position.

It is preferred that the circumferential bending device has, as a first bending unit, a first twisting crown with an annular wall, at the axial end of which the first arrangement of receiving pockets is formed, wherein radially inner receiving pockets are formed by inner grooves formed radially inwards and open at the axial end and radially outer receiving pockets are formed by radially outer grooves formed radially outwards and open at the axial end.

It is preferred that the circumferential bending device has, as a second bending unit, a second twisting crown with an annular wall, at the axial end of which the second arrangement of receiving pockets is formed, wherein radially inner receiving pockets are formed by inner grooves formed radially inwards and open at the axial end and radially outer receiving pockets are formed by outer grooves formed radially outwards and open at the axial end.

According to another aspect, the invention provides a computer program comprising instructions that cause the conductor end shaping device according to any one of the preceding embodiments to perform the conductor end shaping method according to any one of the preceding embodiments.

Preferably, the first radial position and the second radial position have a distance from each other that is less than twice the radial thickness d of the conductor ends measured in the radial direction. Preferably, this distance is less than the radial thickness d of the conductor ends.

Preferably, the intermediate radial position is offset relative to the first or the second position by an amount f*d in the radial direction, where d is the radial thickness of the conductor ends and f is a factor with 2<f<0.05, preferably 1.5<f<0.1, in particular 1<f<0.2. Particularly preferably, the intermediate position is centrally between the first and the second position.

In the following, some advantages, functions and special features of preferred embodiments compared to the prior art will be explained in more detail.

Preferred embodiments of the invention relate to a method and a tool for widening and twisting a stator. Particular embodiments of the invention relate to the field of manufacturing stators for electric mobility.

Preferably, a radial bending device comprising combination widening tools, in particular combination grippers, with a related sequence is provided for widening. In particular, a sequence of the widening step is predetermined in order to prepare the subsequent twisting step for achieving special coil windings.

Preferably, there is a simultaneous use of different widening tools, such as grippers in particular, to create a scheme (single, pairs, combinations).

Preferably, parameterization of the individual pins and control via master pins is provided.

Preferably, widening to different (radial) positions is performed (engaging/gripping simultaneously, but releasing differently, with stop or on-the-fly).

Preferably, a twisting tool with internally and externally grooved twisting crowns is provided. This allows single pins and pin pairs to be twisted in a manner especially adapted to the desired winding scheme of the stator.

Preferred embodiments of the invention are used in a sub-sector of electric motor production, more precisely in the stator production sector for traction drives (electrically driven vehicles, in particular cars and trucks). In particular, methods and devices according to embodiments of the invention are used in the production of so-called hairpin stators, which stand out by their characteristic copper flat wires in the form of “hairpins”. In particular, the hairpins are formed of copper or the like, with a substantially rectangular cross-section and an outer insulator coating, and have a first leg, a second leg and a substantially roof-shaped bend therebetween, the so-called winding head. The hairpins are preferably inserted axially with their legs into a core of individual sheets layered on top of one another, with the end of the pins (example of conductor ends) projecting beyond the laminated core. The number of slots in the stator can vary, depending on the desired number of poles. To generate a rotating field, the straight wire ends protruding from the stator are interconnected in a special sequence so that they form pole pairs among each other. The magnetic fields created by supplying alternating current cause the rotor to rotate due to repulsive or attractive forces.

In hairpin stator production, the conductors are rotated against each other to generate an electrical flux, so that contact is made between selected conductor ends. For this purpose, the conductor ends protruding straight from the laminated core are radially widened in a first step (referred to as step a) above). Preferably, the conductor ends are fixed in place by a gripping process and bent outward or also inward in the radial direction. The resulting distances between the individual conductor ends or several pairs of conductor ends of a slot are advantageous for twisting them against each other in the subsequent process (referred to as step b) above) with the aid of a twisting tool (example of a circumferential bending device). For this purpose, the widened conductor ends are preferably inserted in a twisting crown provided with grooves, which twisting crown can be rotated in any direction. By rotating several such twisting crowns, certain conductor ends can be placed in relation to each other. The conductor ends (in particular wire ends) that belong together can then be joined together, for example, by means of a welding process. To ensure process-safe joining, the distances between the partners to be joined must not be too large.

According to document [3], pairs of conductor ends are already widened jointly. The jointly widened pairs of conductor ends are then twisted using externally and internally grooved twisting crowns. Other widening tools, such as those known from [9] to [11], can also be used to widen individual or groups of conductors, in particular in pairs.

In some hairpin stators there are winding schemes in which only pairs of conductor ends of a common ring of hairpins, extending over two adjacent positions, are connected. The electrical connection of the rings is then established via special pins or via separate winding heads. Since the winding heads for the individual hairpins are usually shaped before the hairpins are assembled into rings, the costs for the production and provision of the hairpins are higher in this case.

Advantageous embodiments of the invention, on the other hand, enable winding schemes in a flexible and process-safe manner in which electrical connections between rings are realized by connecting at least one conductor end of one ring to at least one conductor end of the other ring (a position jump is realized on the twisting side). This is achieved by adapting the widening and twisting for different conductor ends. Although the widening and twisting becomes somewhat more complex, this allows the number of different winding head geometries to be reduced. Advantageous embodiments of the invention enable increased or enhanced process stability despite the more complex widening and twisting, without the need for additional process steps.

Advantageous embodiments of the invention enable a more flexible manufacturing process for stators whose position jump is realized by contacting conductor ends at intermediate positions in order to get by with a smaller number of different winding head geometries. Advantageous embodiments of the invention further make it possible to establish a reliable and positionally accurate widening and twisting process even for complex twisting variations, which contributes significantly to an increase in the process stability of subsequent operations. Preferably, a flexible manufacturing process is made possible by a combination of different widening tools, such as tools for individual conductor ends, for pairs of conductor ends and in combined form (for individual conductor ends and for pairs of conductor ends). Accordingly, the twisting tools are preferably also adapted and optimized to the given boundary conditions. Preferably, the final positions of the stator's conductor ends are reproduced as accurately as possible by the widening and twisting processes. In particular, challenges arise here due to a large number of variants in the geometric design and the electrical connection of the stator. The tools and the process sequences used in the processes and devices according to preferred embodiments of the invention can accordingly be flexibly adapted to the existing workpiece, under the premise of improved process stability and an at least neutral cycle time.

Preferred embodiments of the method and device according to the invention create a coordinated concept of adapted tools and process sequences. By differentiating the individual widening tools into single widening tool, double widening tool and combination widening tool such as, in particular, single, double and combination grippers, a widening concept adapted to the respective desired stator can be established, in which each widening tool such as, for example, each gripper can be individually controlled and actuated separately in each process step. By combining different widening tools, such as grippers in particular, with a tuned process control system, it is possible to reproduce almost any interconnection scheme of the stator's twisting side.

Particularly preferred embodiments of the method and device according to the invention comprise the creation of a special widening and twisting pattern which directly reflects the electrical interconnection of the stator and which can represent both regular and irregular switching schemes with and without position jumps on the twisting side. Among other things, more than one diameter per position can be realized. By positioning the pins for the subsequent twisting process with individually designed twisting tools, which in some particularly preferred embodiments have both external and internal grooves on a tool, an intermediate product can be produced that comes as close as possible to the final state. This is characterized by the minimum possible pin spacing between the pin ends of the stator that belong together.

In prior art, only sequential widening and twisting operations are described so far, dealing either with the processing of a single pin or with the processing of a regular pair. However, no specific reference is made to the electrical interconnection and thus the position of the pins. In a preferred embodiment of the process according to the invention and the device tuned thereto, the still unwelded hairpin ends can be processed with positional accuracy. In this way, all the pins that belong together can be brought together to form a pair already during the widening and twisting process. Mechanical shaping or displacement of the pins in the subsequent processing step can be largely dispensed with. This in turn leads to increased process reliability with regard to the positioning of the pin ends and thus to a reduced reject rate in the subsequent processes.

In the process according to the invention, some conductor ends are positioned at a first radial position and some conductor ends are positioned at a second radial position during widening. The conductor ends widened to the first radial position are received for twisting in a first arrangement of receiving pockets on a first bending unit, and the conductor ends widened to the second radial position are received for twisting in a second arrangement of receiving pockets on a second bending unit. Twisting is achieved by relative rotation of the bending units and thus of the first and second arrangement of receiving pockets.

In addition, however, further conductor ends are positioned at an intermediate radial position between the first and second radial positions during widening. This can be achieved in particular by engaging, in particular gripping, conductor ends in pairs or by combining a paired and single engagement, in particular gripping action.

At least one bending unit of the circumferential bending device has in preferred embodiments thereof inner and outer receiving pockets to provide another arrangement of receiving pockets at the intermediate radial position in addition to the associated arrangement of receiving pockets. Depending on the design and arrangement, the inner or the outer receiving pockets may be located at the at least one intermediate radial position. As is already known in principle from [3], receiving pockets arranged close to one another and open to one another even allow very close adjacent conductor ends to be twisted relative to one another. In this way, in addition to the conductor ends widened to the first and second radial positions, the conductor ends widened to the intermediate radial position can also be reliably twisted.

This provides a high degree of flexibility for twisting and widening in such a way that, for example, pairs of conductor ends to be connected can also be positioned close to each other at intermediate radial positions.

### BRIEF DESCRIPTION OF THE DRAWINGS

An exemplary embodiment will be explained in more detail below with reference to the accompanying drawings, wherein:

FIG. 1 shows a schematic block diagram of an embodiment of a stator manufacturing device for manufacturing a stator of an electric machine provided with coils;

FIG. 2 shows a schematic plan view of a stator component in the form of a core of the stator during an insertion of conductors;

FIG. 3a shows a first step in inserting conductor ends formed by widening and twisting in a conventional manner into a clamping and fixing device to form pairs of conductor ends to be welded;

FIG. 3b shows a second step of the first step shown in FIG. 3a;

FIG. 4 shows a plan view of a twisting side of the stator component with pairs of conductor ends to be welded after twisting for a stator of a first category, in which a position jump is implemented via separate layer hairpins;

FIG. 5 shows a plan view of the twisting side of the stator component with pairs of conductor ends to be welded after twisting for a stator of a second category, in which a position jump is realized on a twisting side;

FIG. 6 shows a plan view in axial direction of a radial bending device of the stator manufacturing device according to a preferred embodiment;

FIG. 7a shows a schematic representation of a first step in a gripping process for gripping a single conductor end during widening by means of a first gripper of the radial bending device which has a first and a second gripping jaw;

FIG. 7b shows a schematic representation of a second step in the gripping process of FIG. 7a;

FIG. 7c shows a schematic representation of a third step in the gripping process of FIG. 7a;

FIG. 7d shows a schematic representation of a fourth step in the gripping process of FIG. 7a;

FIG. 8 shows a perspective view of a gripping jaw of the first gripper;

FIG. 9 shows a perspective view of a gripping jaw of a second gripper of the radial bending device;

FIG. 10 shows a perspective view of a gripping jaw of a third gripper of the radial bending device;

FIG. 11 shows a schematic block diagram illustrating examples of first to fourth different widening sequences for widening conductor ends sticking out together from a stator slot respectively;

FIG. 12 shows a perspective view of a bending unit designed as a twisting crown of a circumferential bending device of the stator manufacturing device used for twisting;

FIG. 13 shows a detail XIII of FIG. 12, showing radially inner and radially outer receiving pockets;

FIG. 14 shows an axial plan view of an end of a first twisting crown provided with receiving pockets and located radially farther outward, with conductor ends received in a radially inner and a radially outer receiving pocket of the first twisting crown, and a radially farther inward second twisting crown indicated by a dashed line;

FIG. 15 shows an illustration of the second twisting crown in an initial position, wherein conductor ends are received in a radially inner and a radially outer receiving pocket and adjacent twisting crowns are indicated by dashed lines;

FIG. 16 shows an illustration as in FIG. 15 after a relative movement of the adjacent twisting crowns to be performed for twisting, in order to form pairs of conductor ends with a small distance to each other; and,

FIG. 17 shows TABLE 1 which is an exemplary structure of an interconnection of a stator after widening (upper part of the table) as well as after twisting (lower part of the table).

### DETAILED DESCRIPTION OF THE PREFERRED EMBODIMENTS

In the following, preferred designs of devices and methods for carrying out manufacturing steps in a sub-sector of electric motor production, more precisely the sector of stator production for traction drives, are described with reference to the attached drawings.

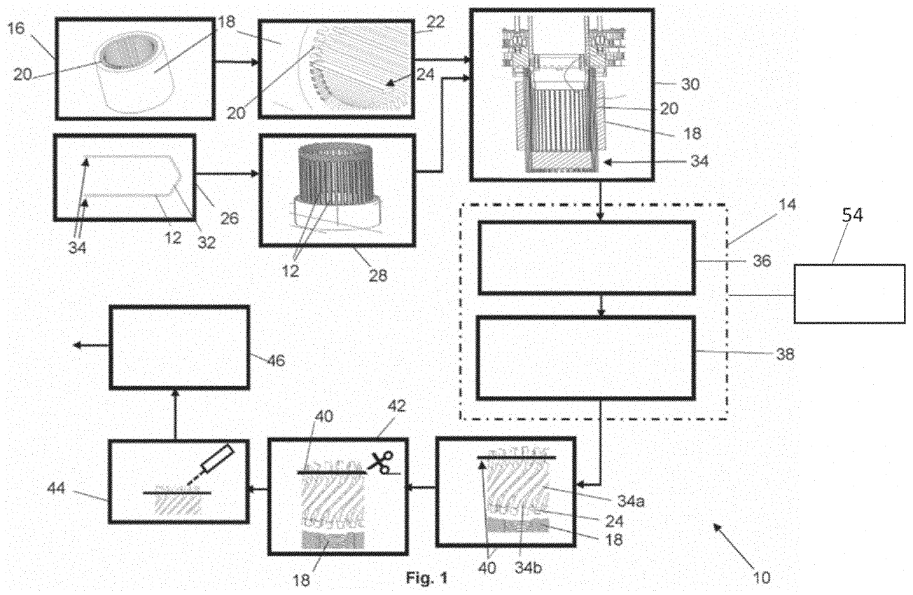

In FIG. 1, one embodiment of a stator manufacturing device 10 for manufacturing a stator 50 of an electric machine provided with coils is shown as a block diagram, thereby also illustrating manufacturing steps of a corresponding stator manufacturing method for manufacturing the stator 50.

The stator 50 to be produced by the stator manufacturing device 10 is intended to be used in particular as the stator 50 of a traction motor of an electric vehicle, preferably in the power range from 20 kW to 400 kW. For this purpose, the stator 50 is to be provided with as large a number of coils as possible, the coils being produced from hairpins 12.

In the illustrated embodiment, the stator manufacturing device 10 includes a conductor end shaping device 14 and preferably one or more or all of the additional stations described in more detail below.

Preferably, the stator manufacturing device 10 has a laminated core manufacturing device 16 for manufacturing the stator component 18 of the stator 50 which is formed as a laminated core and is to be provided with coils. The laminated core manufacturing device 16 is designed, for example, in a generally known manner in order to manufacture the stator component 18 from individual laminated core layers, the stator component 18 being of annular design and being provided on an inner wall region with a row of stator slots 20 that are formed in a distributed manner on the inner wall and are used to accommodate conductor segments.

Preferably, the stator manufacturing device 10 has a device 22 for producing slot insulations, by means of which the individual stator slots 20 are provided with a slot insulation 24, preferably of insulation paper. The device for producing slot insulations 22 is preferably implemented in the manner described in more detail in document [6].

The stator manufacturing device 10 further comprises a hairpin manufacturing device 26 for manufacturing the hairpins 12. The hairpin manufacturing device 26 may comprise, for example, cutting means (not shown) for cutting off pieces of wire from a coil of wire, and bending means, not shown in more detail, for producing a roof bend and/or a kink bend and/or a 3-dimensional bend of the hairpins 12.

Preferably, the stator manufacturing device 10 comprises a pre-positioning device 28 for pre-positioning the hairpins 12 and a hairpin insertion device 30 for inserting the thus pre-positioned hairpins 12 into the stator slots 20 of the laminated core 18. Possible embodiments of the pre-positioning device 28 as well as the hairpin insertion device 30 are shown and described in more detail in document [7]. In particular, in the pre-positioning device 28, the hairpins 12 are pre-positioned to form rings.

As indicated at the hairpin manufacturing device 26, the hairpins 12 have a curved winding head 32 as well as two legs with free conductor ends 34, wherein they are provided with an insulation, for example a plastic coating, except for the outermost end region at each conductor end 34. After hairpin insertion by means of the hairpin insertion device 30, the conductor ends 34 stick out from the stator slots 20 at one end—twisting side 52—of the stator component 18.

The conductor end shaping device 14 is used to perform the widening process, where the individual conductor ends 34 are widened in the radial direction, and to perform the twisting process, where the conductor ends 34 thus widened are shaped in the circumferential direction to form respective pairs of conductor ends 34 to be connected to each other.

For this purpose, the conductor end shaping device 14 has a radial bending device 36 and a circumferential bending device 38. Further, the conductor end shaping device 14 comprises a controller 54. The controller 54 can be part of a central control system of the stator manufacturing device 10 or a separate decentralized controller 54 of the conductor end shaping device 14. The controller 54 is configured as an electronic controller having a memory to which a corresponding computer program with instructions for performing the conductor end shaping process is loaded, as will be discussed in further detail later.

The stator manufacturing device 10 may further comprise a clamping and/or fixing device 40 for clamping and/or fixing the individual pairs of conductor ends 34 to be connected. One embodiment of the clamping and fixing device 40 is shown and described in document [8].

The stator manufacturing device 10 may further comprise a conductor end cutting device 42 for cutting the conductor ends 34 clamped and fixed with the clamping and/or fixing device 40.

One embodiment of the stator manufacturing device 10 further comprises a conductor end welding device 44 for welding the conductor ends 34 to be connected to each other to form the coils.

Further, the stator manufacturing device 10 may comprise devices 46 for electrically contacting the coils thus formed by the hairpins 12 and/or for testing and/or casting the stator 50 thus formed.

In the following, embodiments of the conductor end shaping device 14 of the stator manufacturing device 10 and the conductor end shaping processes to be performed therewith are explained in more detail.

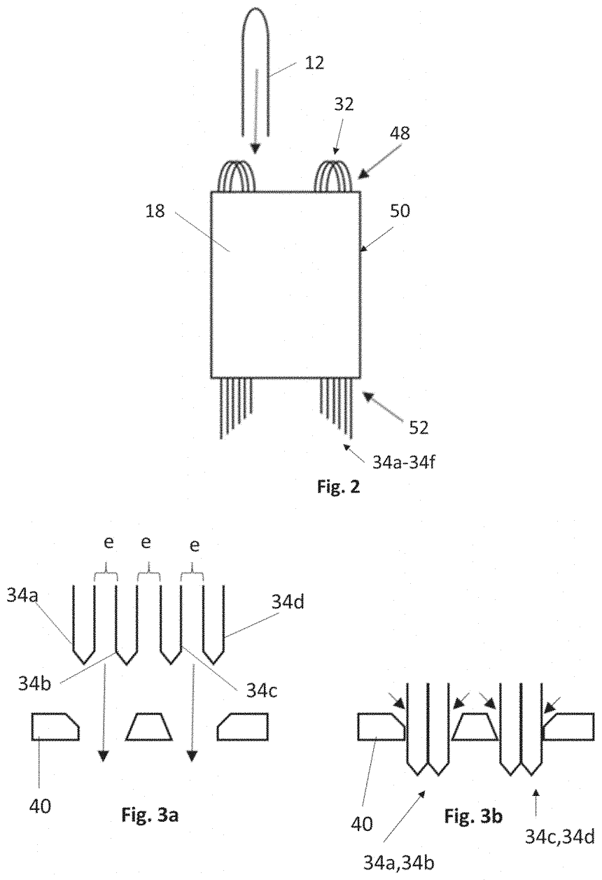

In the stator manufacturing device 10 according to the embodiment shown in FIG. 1, for the manufacture of a stator 50 as an example of the component, first a laminated core with stator slots 20 and slot insulators 24 accommodated therein are provided as a stator component 18; at the same time, conductors in the form of hairpins 12 are manufactured. The conductors in the form of hairpins 12 are then inserted into the stator component 18, as indicated in FIG. 2. FIG. 2 shows the stator component 18 with the hairpins 12 already inserted or in the process of being inserted.

The side from which the individual hairpins 12 are inserted into the stator component 18 is referred to as the winding head side 48 or insertion side. In contrast, the side of the stator 50 facing away from the insertion side is referred to as the twisting side 52. This is characterized by the protruding stripped conductor ends 34 of the hairpins 12. To create a closed circuit, the conductor ends 34a-34f are connected to each other in a defined manner.

In general, there are several ways in which these conductor end pairings and thus a closed circuit can be created in current hairpin stator manufacturing processes. One option is to bring the conductor ends 34a-34f individually radially to a certain diameter. The minimum distance e between the conductor ends 34a-34f is defined by the wall thickness of the twisting tools. As FIGS. 3a and 3b show, after the twisting process has been completed, the individual conductor ends 34a-34d are moved towards each other by the clamping and fixing device 40 and then welded. The distance e between the conductor ends 34a-34d and the position tolerances of the individual conductors must be compensated for by the subsequent process. With limited installation space, the individual areas in which the conductor ends 34a-34d can be reliably guided towards each other cannot be designed arbitrarily large. The offset that occurs thus significantly reduces the process stability of the subsequent welding process. FIGS. 3a and 3b show successive steps in the insertion of two pairs of conductor ends 34a, 34b and 34c, 34d to be welded into the clamping and fixing device 40 according to a conventional conductor end shaping process. There is a distance e between adjacent conductor ends 34a-34d in each case, and the distance e must be reduced by the clamping and fixing device 40 in the case of pairs to be welded. In unfavorable cases, this can lead to process instabilities.

One way of reducing the distance e is to widen at least some of the conductor ends 34a-34f already “in pairs”. In this case, conductor ends 34a, 34b are already radially widened in pairs during the widening process preceding the twisting process. The subsequent twisting process is characterized by a significantly smaller distance between the conductor ends of a pair and thus by increased process stability. Document [3] also already proposes a pairwise widening process, but merely considers “regular” interconnections without layer jump on the twisting side. A “layer” is defined as all conductor ends on a common diameter. On the stator 50 itself, a distinction can be made between two different sides, the twisting side 52 as well as the winding head side 48.

To create the closed circuit, the conductor ends 34, 34a-34h are connected to each other in a defined manner on the twisting side 52. Usually, the legs of the hairpin 12 are bent in such a way that they come to lie in two different, adjacent positions or diameters. For example, the first leg—conductor end 34a—of a first hairpin is in the outermost position, whereas its second leg—conductor end 34b—is inserted into the second position from outside, offset by a few slots. The different positions and the resulting pairing of adjacent conductor ends 34 result in closed circuits being established.

Depending on the hairpin geometries used—in particular the geometries of the winding heads 32 on the winding head side 48—as well as the pairs formed on the twisting side 52, the stators 50 can be divided into two different categories.

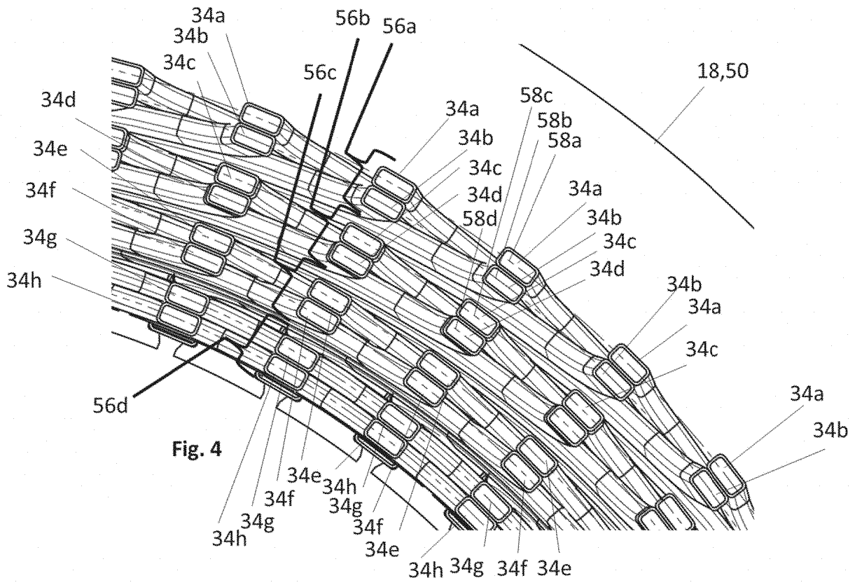

In the first category of stators, of which an example is shown in FIG. 4, the layer jump is realized by means of so-called “layer pins”. These are particular hairpins 12 (“special pins”) which establish a connection between two rings 56a-56d, for example between a first ring 56a and a second ring 56b. A “ring” is defined as two adjacent positions that belong together. In particular, the ring 56a-56d is a wreath-shaped arrangement of hairpins 12, the first leg of each of which is located at one of the adjacent positions and the other leg of each of which is located at the other of the adjacent positions. As an example, a primary position 58a and a secondary position 58b together form the first ring 56a, whereas a tertiary position 58c and a quaternary position 58d form the second ring 56b. As a result, pairing on the twisting side is limited only between hairpins 12 of a ring 56a or 56b, such as between the primary and secondary positions 58a and 58b and between the tertiary and quaternary positions 58c and 58d, etc. As a result of the interconnection via special hairpin geometries, the number of different hairpin types increases, and with it the complexity of bending the individual winding heads 32. The resulting regular pattern without direct connection between the rings on the twisting side is characterized by the fact that all conductor ends 34a-34h of a position are on the same diameter, as shown in FIG. 4. In total, in the example of the stator with eight conductor segments, four rings 56a-56d are formed per stator slot, the conductor ends of which are located at eight regular radial positions 58a-58h.

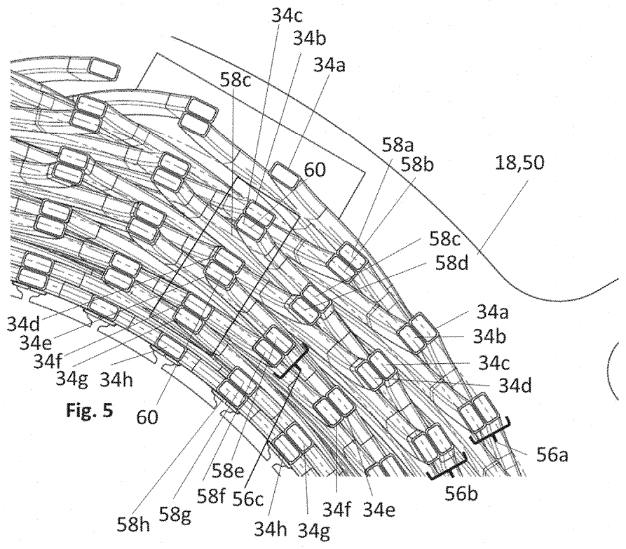

In contrast, FIG. 5 shows an example of a stator 50 of the second category in which the layer jump is realized on the twisting side 52. Hairpin stators 50 of the second category can generally be constructed from a smaller number of different hairpins 12 compared to stators of the first category. The smaller number of different hairpin types reduces the effort of having to provide different winding heads 32.

As shown in FIG. 5, some conductor ends 34b-34g of the hairpins 12 are bent so that they leave their actual position 58a-58h and come to lie at at least one intermediate position 60 between two rings 56a-56d. The at least one intermediate position 60 is between adjacent positions in each case, such as between the positions 58b and 58c of the rings 56a and 56b.

By contacting two such conductor ends 34b-34g, at least one of which is located at an intermediate position 60, on the twisting side 52, an electrical connection can be established between the different rings 56a-56d of the stator 50. In contrast to the previously described stators of the first category, these stators 50 of the second category manage without (or at least with a smaller number of) layer pins.

As can be seen by comparing the conductor ends 34b-34g highlighted in a frame in FIG. 5 with the conductor ends 34a-34h arranged to the right of them in the circumferential direction, which are located at the regular positions 58a-58h, all of the conductor ends 34b-34g connected for a layer jump can be located at intermediate positions 60 slightly offset with respect to the regular positions 58a-58h.

In some embodiments, the diameter (i.e. radial position) of the pairs of conductor ends 34b, 34c at the intermediate position 60 differs from that of the individual positions 58a-58h. In preferred embodiments, the diameter of the intermediate position 60 is—preferably centrally—between the diameters of the two adjacent positions 58b, 58c involved.

The simplification of the winding head 32 due to the reduced number of different hairpin geometries is compensated here by the more complex twisting side 52. The spreading of the conductor ends 34b-34g of a position 58b-58g to two different diameters previously contributed significantly to a reduction in process stability, since only one position could be realized with the previous twisting tools. Thus, when using previously known conductor end shaping devices, the displacement of the conductor ends 34 to the respective diameter had to be assigned to the downstream process. For described stators 50 of the second category, there are currently no known technical solutions for increasing the positioning accuracy and thus increasing the process stability. FIG. 5 shows an exemplary winding scheme with layer jump on the twisting side 52 and the resulting intermediate positions 60.

In the following, a conductor end shaping method and a conductor end shaping device 14 are described, with which a flexible manufacturing process can be carried out for stators 50 of the second category, the layer jump of which is realized by contacting the conductor ends 34b-34g at intermediate positions 60. In particular, the widening and twisting for the conductor ends 34a-34h for the manufacture of such stators 50 with layer jump by contacting on the twisting side 52—for which an individual winding scheme is predetermined—shall be feasible in a process-safe manner Preferably, a reliable and positionally accurate widening and twisting process should also be established for complex twisting variations, which contributes significantly to an increase in the process stability of subsequent operations.

Advantageously, a flexible manufacturing process is obtained by a combination of different widening tools 61-1, 61-2, 61-3, such as first widening tools 62-1 for individual conductor ends, second widening tools 61-2 for conductor end pairs and, if necessary, third widening tools 61-3 in the form of combination widening tools in combined form for individual conductor ends and for pairs of conductor ends. Accordingly, in preferred embodiments of the conductor end shaping process as well as of the conductor end shaping device 14, the twisting tools are also adapted and optimized to the given boundary conditions. Execution and control are carried out in such a way that the final postures of the conductor ends 34a-34h of the stator 50 are reproduced as accurately as possible by the widening and twisting processes. Challenges arise due to the large number of variants of the geometric design as well as the electrical interconnection of the stator 50 in different stator product series. Preferred designs of the tools and process sequences used can accordingly be flexibly adapted to the existing workpiece, on the premise of improved process stability and at least neutral cycle times relative to previous conductor end forming processes.

In the following, preferred embodiments of the conductor end shaping process and the conductor end shaping device 14 are explained in more detail on the basis of the attached Figures. The conductor end shaping process can be carried out by means of the conductor end shaping device 14. The conductor end shaping device 14 is configured to perform the conductor end shaping process.

The conductor end shaping method is for shaping conductor ends 34a-34h that stick out from the arrangement of stator slots 20 of the stator component 18 extending annularly around a central axis.

The conductor end shaping method comprises the step of:

a) widening the conductor ends 34a-34h by bending the conductor ends 34a-34h in a radial direction by means of a plurality of widening tools 61-1, 61-2, 61-3, such as grippers 62-1, 62-2, 62-3, of the radial bending device 36, such that the widening causes a first part of the conductor ends 34b to be situated at a first radial position 58b and a second part of the conductor ends 34c to be situated at a second radial position 58c.

Step a) comprises the step of:

a1) engaging at least one individual conductor end by at least a first widening tool 61-1 such as a first gripper 62-1 to bend the at least one individual conductor end thus engaged individually in the radial direction, and jointly gripping at least one pair of radially adjacent conductor ends 34e, 34f by at least a second widening tool 61-2 such as a second gripper 62-2 to jointly bend the pair of radially adjacent conductor ends in the radial direction, wherein step a1) is performed such that a third part of the conductor ends 34e is situated at at least one intermediate radial position 60 between the first and second radial positions 58b, 58c.

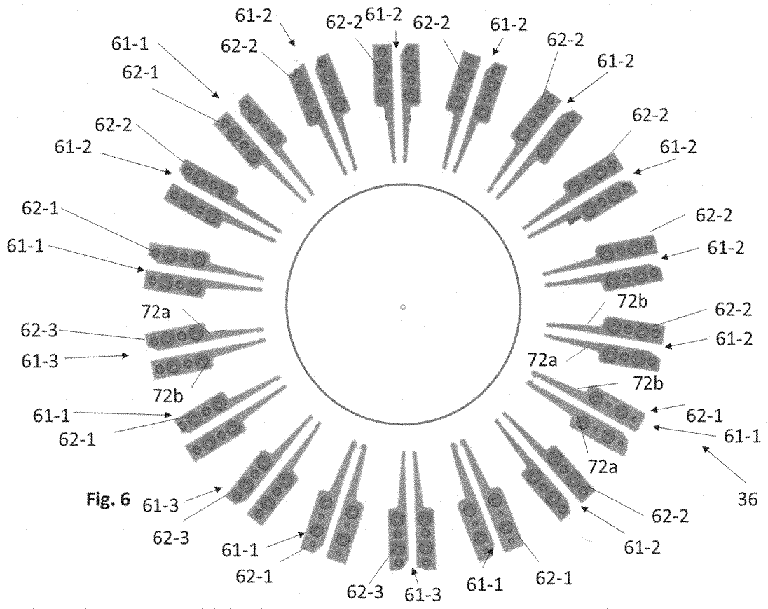

As can be seen from FIG. 5, the radially further inward conductor ends 34b of the radially outermost first ring 56a are situated at the “regular” radial secondary position 58b (second position viewed from the outside), while the radially outer conductor ends 34c of the radially outward second ring 56b are situated at the regular radial tertiary position 58c (third position viewed from the outside). By using different widening tools 61-1, 61-2, 61-3 such as grippers 62-1, 62-2, 62-3 or other widening tools known in principle, for example, from the aforementioned documents [9] to [11] and correspondingly adapted for flexible gripping, widening processes can be carried out more flexibly. The widening is carried out in such a way that some of the conductor ends 34c (see, for example, the conductor end 34c in the framing in FIG. 5 as well as the corresponding conductor end adjacent in counterclockwise direction) are situated at the intermediate position 60, as can also be seen in FIG. 5. A preferred radial bending device 36 with grippers 62-1, 62-2, 62-3 as widening tools 61-1, 61-2, 61-3 is explained in more detail hereinafter with reference to FIGS. 6 to 11.

Further, the conductor end shaping method comprises the step of:

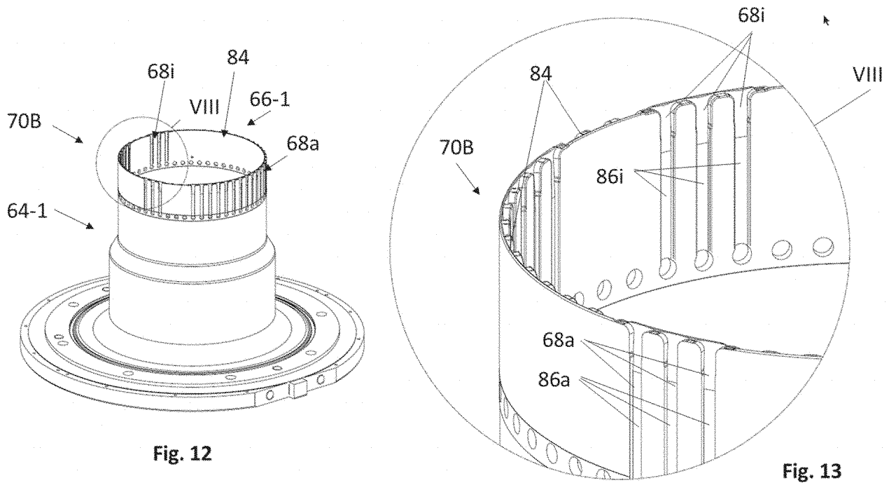

b) twisting the conductor ends 34a-34h by bending in the circumferential direction by means of the circumferential bending device 38, which has a first bending unit 64-1 rotatable in a first direction of rotation and having a first annular arrangement 66-1 of receiving pockets 68 and a second bending unit 64-2 rotatable concentrically thereto in the second direction of rotation and having a second annular arrangement 66-2 of receiving pockets 68. In particular, the bending units 64-1, 64-2 have twisting crowns 70A-70H for forming the annular arrangements 66-1, 66-2, . . . . Examples of embodiments of these bending units 64-1, 64-2 with twisting crowns 70A-70H will be further explained hereinafter with reference to FIGS. 12 to 16.

Step b) comprises the step of:
b0) providing the first and second bending units 64-1, 64-2 in such a way that the bending unit which is located radially further outward has radially inner receiving pockets 68i which are open towards the radially inner side, and the bending unit which is located radially further inward has radially outer receiving pockets 68a which are open towards the radially outer side, wherein
b0-1) a part of the receiving pockets 68a, 68i of the first arrangement is located at the first radial position 58b and another part of the receiving pockets 68a, 68i of the first arrangement 66-1 is radially offset thereto and located at at least one intermediate radial position 60 and/or
b0-2) a part of the receiving pockets 68a, 68i of the second arrangement 66-2 is situated at the second radial position 58c and another part of the receiving pockets 68a, 68i of the second arrangement 66-2 is radially offset thereto and located at the at least one radial intermediate position 60 or another of a plurality of radial intermediate positions 60.

Further, step b) comprises the step of:
b1) inserting the first part of conductor ends widened in step a) to the first radial position 58b into the first arrangement 66-1 of receiving pockets 68a, 68i and inserting the second part of conductor ends widened in step a) to the second radial position 58c into the second arrangement 66-2 of receiving pockets.

This step b1) comprises:

b1a) inserting conductor ends widened to the at least one intermediate radial position 60 into receiving pockets 68a, 68i of the other part of the first or second arrangement 66-1, 66-2 and inserting a radially inner conductor end of each pair of conductor ends bent together in step a1) into one of the radially outer receiving pockets 68a and the radially outer conductor end of the pair into one of the radially inner receiving pockets 68i.

Finally, step b) comprises:

b2) oppositely rotating the first and second bending units 64-1, 64-2 to bend the first part of conductor ends and the second part of conductor ends in opposite circumferential directions.

Accordingly, the conductor end shaping device 14 is adapted to shape conductor ends 34a-34h projecting in the axial direction from the arrangement of stator slots 20 of the stator component 18 extending annularly around a central axis to form a stator 50 of an electric machine. The conductor end shaping device 14 includes a radial bending device 34 for widening the conductor ends 34a-34h with a plurality of widening tools 61-1, 61-2, 61-3 such as grippers 62-1, 62-2, 62-3 formed for bending the conductor ends 34a-34h in the radial direction such that after bending a first part of the conductor ends is situated at a first radial position 58b and a second part of the conductor ends is situated at a second radial position 58c. Further, the conductor end shaping device 14 comprises the circumferential bending means 36 for twisting the conductor ends 34a-34f by bending in the circumferential direction, wherein the circumferential bending means 36 comprises the first bending unit 64-1 rotatable in a first rotational direction and having the first annular arrangement 66-1 of receiving pockets 68a, 68i and the second bending unit 66-2 rotatable in the second rotational direction and arranged concentrically thereto and having the second annular arrangement 66-2 of receiving pockets 68a, 68i. Of the first and second bending units 64-1, 64-2, that bending unit which is located radially further out has radially inner receiving pockets 68i which are open towards the radially inner side. That bending unit which is located radially further in has radially outer receiving pockets 68a which are open towards the radially outer side. In this case, a part of the receiving pockets 68a, 68i of the first arrangement is situated at the first radial position 58b and another part of the receiving pockets 68a, 68i of the first arrangement 66-1 is radially offset thereto and situated at the at least one intermediate radial position 60. Alternatively or additionally, a part of the receiving pockets 68a, 68i of the second arrangement 66-2 is situated at the second radial position 58c and another part of the receiving pockets 68a, 68i of the second arrangement 66-2 is radially offset thereto and situated at the at least one intermediate radial position 60 or another of a plurality of intermediate positions 60. Further, the conductor end shaping device 14 comprises the controller 54, which is adapted to control the conductor end shaping device 14 to
a) widen the conductor ends 34a-34h by bending the conductor ends 34a-34h in a radial direction by means of the plurality of widening tools 61-1, 61-2, 61-3, such as grippers 62-1, 62-2, 62-3, of the radial bending device 36, such that the widening causes a first part of the conductor ends 38a-38h to be situated at the first radial position 58b and a second part of the conductor ends 38a-38h to be situated at the second radial position 58c, by
a1) engaging at least a single conductor end by at least a first widening tool 61-1, such as a first gripper 62-1, to bend the thus engaged conductor end individually in the radial direction, and jointly engaging at least one pair of radially adjacent conductor ends by at least a second widening tool 61-2, such as a second gripper 62-2, to jointly bend the pair of radially adjacent conductor ends in the radial direction, wherein the controller 54 is adapted to carry out control of the grippers 62-1, 62-2, 62-3 such that a third part of the conductor ends 38a-38f is situated at the at least one intermediate radial position 60 between the first and second radial positions 58b, 58c,
b) twisting the conductor ends 34a-34f by bending them in the circumferential direction by means of the circumferential bending device 38 by
b1) inserting the first part of conductor ends 38a-38f widened in step a) to the first radial position 58b into the first arrangement 66-1 of receiving pockets 68a, 68i, inserting the second part of conductor ends 38a-38f widened in step a) to the second radial position 58c into the second arrangement of receiving pockets 68a, 68i, with
b1a) inserting conductor ends widened to the at least one intermediate radial position 60 into one receiving pocket 68a, 68i each of the other part of the first or second arrangement 66-1, 66-2 and inserting a radially inner conductor end of each pair bent together in step a1) into one of the radially outer receiving pockets 68a and the radially outer conductor end of the pair into one of the radially inner receiving pockets 68i, and
b2) oppositely rotating the first and second bending units 64-1, 64-2 to bend the first part of the conductor ends and the second part of the conductor ends in opposite circumferential directions.

Accordingly, the controller 54 is adapted to control the conductor end shaping device 14 to perform the steps of the conductor end shaping process. In particular, a computer program is loaded into the controller 54 with instructions that cause the conductor end shaping device 14 to perform the conductor end shaping process.

Thus, in the conductor end shaping process and the conductor end shaping device 14, conductor ends 34b-34g, which are to be arranged at intermediate radial positions 60 in order to interconnect, for example, two rings 56a/56b, 56b/56c, 56c/56d on the twisting side 52, are already brought to corresponding intermediate radial positions 60 during the widening process. For this purpose, some conductor ends are widened individually and some conductor ends are widened in pairs. At least one of the bending units 64-1, 64-2 has an arrangement 66-1, 66-2 of receiving grooves 68a, 68i with radially inner and radially outer receiving grooves in order to also provide receiving grooves 68a, 68i at the radially intermediate position 60. A part of these receiving grooves 68a, 68i serves to receive the conductor ends 34a-34h at the regular positions 58a-58h, in particular the conductor ends 34a-34h of the rings 56a-56d; another part of these receiving grooves 68a, 68i serves to receive the conductor ends 34b-34g widened to the at least one intermediate position 60, such as the conductor ends to be connected for a position jump.

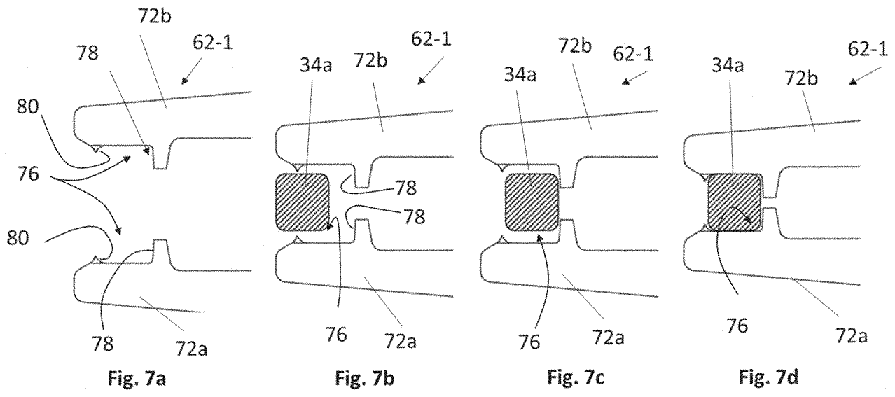

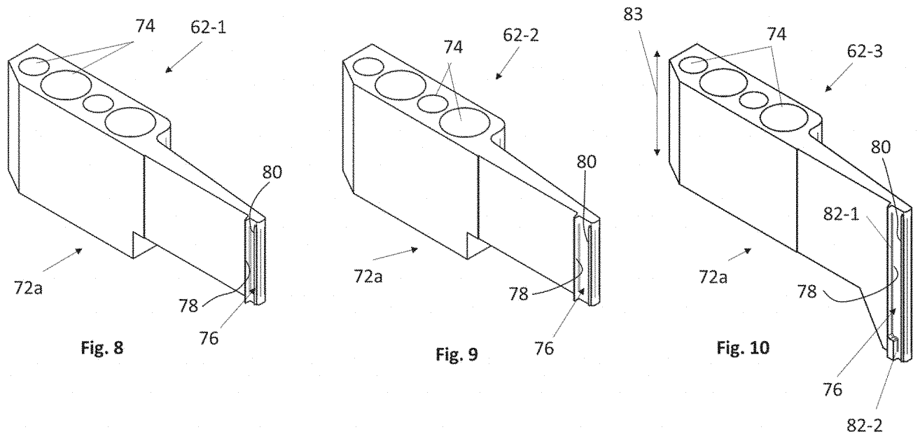

In the following, one embodiment of the radial bending device 36 for widening the conductor ends 34a-34h will be explained in more detail with reference to the illustration of FIGS. 6 to 11. In principle, the radial bending device 36 can be constructed according to preferred embodiments as described and shown in documents [1] and [2], but instead of the same grippers, several different grippers 62-1, 62-2, 62-3 are provided, as shown in FIG. 6. Each of the grippers 62-1, 62-2, 62-3 has a first and a second gripping jaw 72a, 72b which, controlled by the controller 54, are movable towards each other for gripping conductor ends 34a-34h and away from each other for releasing conductor ends 34a-34h, as shown in FIGS. 7a to 7b using the example of the first gripper 62-1, which is designed for gripping a single conductor end 34a. FIG. 8 shows the first gripping jaw 72a of the first gripper 62-1, FIG. 9 shows the first gripping jaw 72a of the second gripper 62-2, and FIG. 10 shows the first gripping jaw 72b of the third gripper. The respective second gripping jaw 72b is formed as a mirror image of the first gripping jaw 72a and is therefore not shown in FIGS. 8 to 10.

In addition to connection bores 74 for fastening, the respective gripping jaw 72a, 72b of each gripper 62-1, 66-2, 66-3 has a defined gripping area 76, which is bounded by two projecting shoulders 78, 80. While the rear shoulder 78 is used for fixing the conductor end 34a-h, the front shoulder 80 is used for bending the conductor end 34a-h, see FIGS. 7a-7c. With the aid of the shoulders 78, 80, one or more conductor ends 34a-34h can be positively gripped and deformed. The distance between the shoulders 78, 80 is defined by the number of gripped conductor ends 34a-34h.

FIGS. 7a-7c show an exemplary gripping process for a single pin—single conductor end 34a-34h. Since the shoulder 80 of the gripper 62-1, 62-2, 62-3 facing away from the center axis of the radial bending device 36 must always engage in the slot area before the conductor end 34a-34h to be gripped, a minimum wide spacing must be provided between each conductor end 34a-34h in the respective stator slot 20. This wide spacing ultimately translates into the design of the twisting tools, whose receiving grooves 86a, 86i require a defined spacing from one another.

To better position the conductor ends 34a-34h relative to each other, they can also be gripped and widened in pairs. For this purpose, grippers with a larger gripping area 76, so-called “double grippers”, are used as second grippers 62-2. Their gripping area 76 is designed in such a way that two or more conductor ends 34a-34h can be gripped at the same time, see FIG. 9. Thus, there is no wide gap between the conductor ends 34a-34h of a pair of conductor ends.

However, not all conductor ends 34a-34h are directly widened as a pair during the widening process. Thus, it is also possible that pair formation is not completed until the subsequent twisting process in which two adjacent positions 58a/58b, 58b/58c, 58c/58d, 58d/58e, 58e/58f, 58f/58g, 58g/58h are rotated against each other. An example of single gripping can be taken from the flow chart in FIGS. 7a-7c. For this purpose, single grippers are used as the first grippers 62-1. Their gripping area 76 provides sufficient space for only a single conductor end 34a-34h, see FIGS. 7a-7c and FIG. 8.

In addition, some of the conductor ends 34a-34h sticking out from a stator slot 20 may have to be gripped as a pair and others of these conductor ends 34a-34h sticking out from the same stator slot 20 may have to be gripped individually and widened radially. For this purpose, combination grippers are used as third grippers 62-3, the gripping area 76 of which is divided, preferably axially, into at least two gripping sections 82-1, 82-2, see FIG. 10. In the first gripping section 82-1 shown in FIG. 10 above, two conductors can be fixed and widened simultaneously, as in the case of the double grippers. Their conductor ends protrude into the third gripper 62-3, but not as far as to the second, offset gripping section 82-2. Here, the gripping contour narrows so that there is room for only one conductor end therein. Depending on the insertion depth, which can be set by the controller 54 as indicated by the double arrow 83 in FIG. 10, and the radial position of the third gripper 62-3, it can thus be ensured whether one or two conductor ends 34a-34h are widened at the same time.

The use of single, double or combination grippers—first to third grippers 62-1, 66-2, 66-3—depends on the design of the twisting side 52 and may vary for each (type of) stator 50. All types of grippers 62-1, 62-2, 62-3 may be used mixed around the circumference.

In other embodiments of the radial bending device 36 not shown in detail here, appropriately modified other widening tools 61-1, 61-2, 61-3 are used instead of grippers. Combinations of different types of widening tools are also possible.

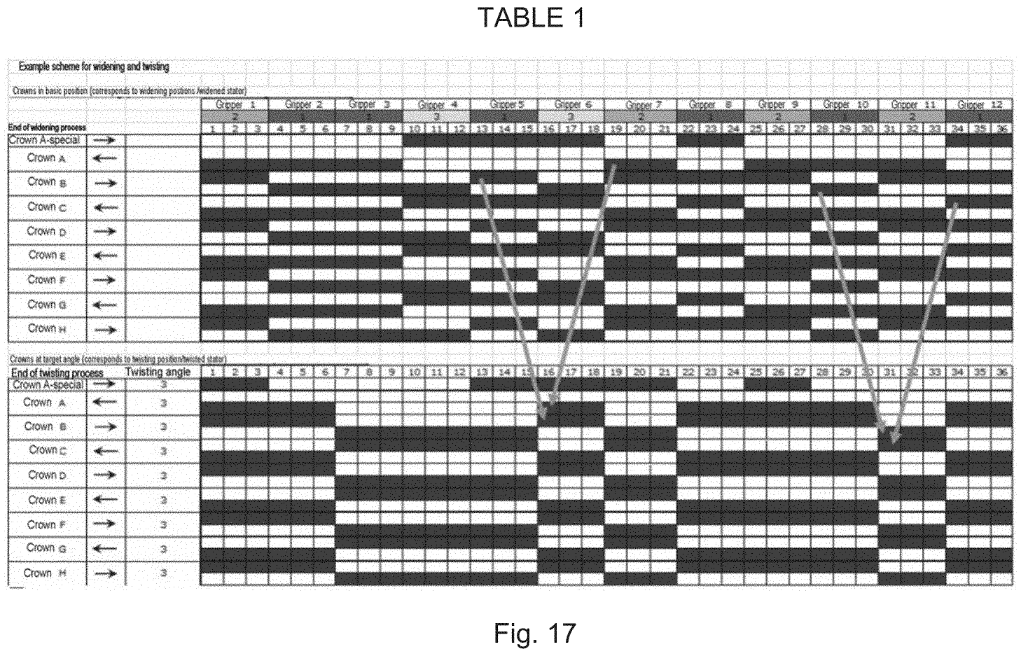

In TABLE 1, FIG. 17, an exemplary structure of an interconnection of a stator 50 after widening (upper part of TABLE 1) as well as after twisting (lower part of TABLE 1) is shown. The final result of the widening process forms the basis for the subsequent twisting process. The final position of the latter can be derived from the displacement of the conductor ends 34a-34h of a position 58a-58h by a defined clockwise or counterclockwise angle. A multiple of the distance between two stator slots 20 is usually selected as the twisting angle.

In the upper part of TABLE 1, the exemplary conductor end positions of the first to 36th stator slots 20 (shown as numbers 1-36 in the third row) are shown after widening. Twelve grippers are provided, each for widening the conductor ends 34a-34h of three adjacent stator slots 20. The first row indicates the grippers 1 to 12, and the second row indicates their type (1=single gripper, i.e. first gripper 62-1; 2=double gripper, i.e. second gripper 62-2; 3=combination gripper, i.e. third gripper 62-3). For each position A to H, a distinction is made between an outer (upper row of the position) and an inner (lower row of the position) position. The position of the conductor ends corresponds to the position of the individual conductor ends and is of importance for the subsequent design of the correspondingly adapted twisting crowns 70A-70H. Depending on the position, an inner groove 86i—for forming an inner receiving pocket 68i—or an outer groove 86a—for forming an outer receiving pocket 68a—is provided on the associated twisting crown, as will be explained further below with reference to FIGS. 12 and 13. It is only the outermost crown 70A where are all conductor ends are widened to only one diameter in this example.

The movement of the individual grippers 62-1, 66-2, 66-3—here a total of twelve grippers—during widening is controlled individually by the controller 54 on the basis of a set of previously stored parameters (control data set). Conductor ends 34a-34h of twelve stator slots 20 can thus be widened at the same time; when all conductor ends 34a-34h of these twelve stator slots 20 have been widened, the stator component 18 is rotated relative to the radial bending device 36 by an angle corresponding to the stator slot spacing in order to widen the conductor ends 34a-34h of the next set of twelve stator slots 20 by the twelve grippers 62-1, 62-2, 62-3. This is repeated again until all conductor ends 34a-34h of all 36 stator slots 20 have been widened. Depending on the design, the relative rotation of the stator component 18 and the radial bending device 36 can be performed by rotating the stator component 18 when the radial bending device 36 is stationary, or by rotating the radial bending device 36 when the stator component 18 is stationary, or by combined rotation of the stator component 18 and the radial bending device 36.

In contrast to the approach previously used in particular for stators of the first category, it is no longer possible in the embodiment shown in TABLE 1 to widen all of the conductor ends 34a-34h of a position A to H (58a-58h) to the same diameter. The mapping of the final positions of the conductor ends of the stator 50 as well as its conductor end pairings require a highly flexible widening process with individually parameterizable conductor ends. Thus, a set of parameters is stored for each conductor end 34a-34h for all stator slots 20 even within a position A to H, which set of parameters ultimately determines the radial position of the conductor end 34a-34h. This can ensure that the conductor ends 34a-34h can always be inserted in the outer groove 86a or inner groove 86i of the twisting crown 70A-70H provided for them.

The increased parameterization effort can be structured and simplified by introducing so-called master control data sets. The widening operations for widening several conductor ends 34a-34h of a position 58a-58h with the same diameter can be combined in terms of control technology to one master widening operation, with the aid of which the number of variants of conductor end positions can be reduced. In this way, the widening operation of each assigned conductor end 34a-34h taps the master control data set (parameter set) of the stored master widening operation. It is possible to flexibly define which parameters for the individual conductor ends are to be taken over by the respective master widening operation. Attributes such as the gripper number, the slot numbers to be processed, etc. can also be specifically parameterized.

If one looks at the previously illustrated exemplary widening scheme, one can see that the individual stator slots require different widening processes. Depending on the position A-H to which the conductor ends 34a-34h are to be widened for the subsequent twisting process, they are either gripped directly together or individually. Whereas, for example, only single widening processes are carried out for stator slots 4-9, 13-15 or 22-24, purely pairwise gripping processes are used for stator slots 1-3 or 19-21. The type of gripping and widening process can be taken from the numbers one (1) to three (3) in the second line (below the designation of gripper one (1) to gripper twelve (12) in the first line). Number one (1) stands for purely single gripping—the first gripper 62-1 is used for this purpose. Number two (2) stands for purely paired gripping—the second gripper 62-2 is used for this purpose. The slots 10-12 and 16-18 are a special case in which both individual conductor ends and pairs of conductor ends must be widened in the radial direction. Here, number three (3) stands for the use of the combined gripper—third gripper 62-3.

Depending on the specified conductor end position of the individual stator slots and the selected gripper type 62-1, 62-2, 62-3, a distinction can be made between different gripping sequences.

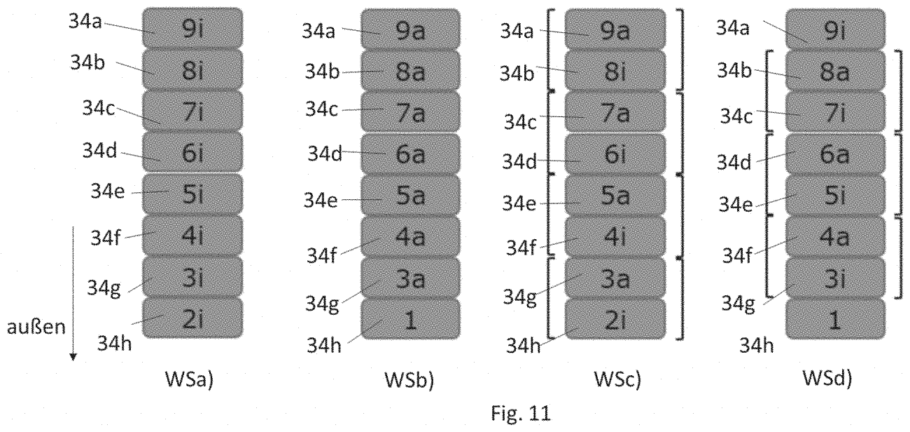

Four exemplary widening sequences are shown in FIG. 11. The widening sequences WSa) to WSd) each show a widening sequence of eight conductor ends sticking out from a stator slot 20, where in this case number one (1) stands for the special conductor ends (see columns 10-18, 22-24 and 34-36 and numbers two (2) to nine (9) stand for the conductor ends to be widened to the positions H to A (which are to be twisted by the crowns H to A) and the letter a stands for the outer row of the respective position H to A and the letter i stands for the inner row of the respective position H to A. The widening sequences WSa) and WSb) are performed by individually widening the individual conductor ends 34a-34h for which the first gripper 62-1 (single gripper) is used. For the widening process of individual pins, an inner end position (widening sequence WSa)) and an outer end position (widening sequence WSb)) can also be distinguished. In the widening sequence WSc), the conductor ends 34a-34h are widened in pairs using the second gripper 62-2. In the widening sequence WSd), the conductor ends 34a-34h are widened in a combined manner, i.e. individually and in pairs, using the third gripper 62-3.

After the conductor ends have been radially widened, they are then twisted against each other in a twisting process. This is done by means of the circumferential bending device 38.

The basic design of the circumferential bending device 38 is in the manner known from documents [1] to [5], the bending units 64-1, 64-2, designed as twisting crowns 70A-70H, being separately adapted to the winding scheme of the stator 50 and the resulting pattern of conductor ends 34a-34h to be connected (see, for example, FIG. 5 or TABLE 1). The twisting crowns 70A-70H have at their free end the annular arrangements 66-1, 66-2 of receiving pockets 68a, 68i. In one embodiment of the circumferential bending device 38, all of the further inwardly disposed twisting crowns 70B to 70H have inner receiving pockets 68i and outer receiving pockets 68a, as shown in FIG. 12 with reference to an exemplary twisting crown 70B. In the exemplary embodiment shown here, the conductor ends 34a of the outermost position A, 58a (with the exception of special conductor ends) lie on a diameter such that the outer twisting crown A has only inner grooves 86i. Some of the conductor ends of the outermost position may be special conductor ends, for example for interconnecting the coil winding, and are twisted by a separate twisting crown A-special.

The twisting crowns 70B-70H each have an annular wall 84, at the axially free end of which is formed the arrangement 66-1, 66-2 of receiving pockets 68a, 68i. The radially inner receiving pockets 68a are formed by inner grooves 86i which are formed radially inwardly and are open at the axial end. The radially outer receiving pockets 68a are formed by outer grooves 86a which are formed radially outwardly and are open at the axial end.

For twisting, the widened conductor ends of the hairpins 12 are inserted into the respective grooves 86a, 86i of the twisting crown 70A-70H. As can be seen from TABLE 1, each position A to H is thereby rotated clockwise or counterclockwise by a certain angle of rotation about its central axis. In addition to the rotational movement of the twisting crowns 70A-70H, the stator component 18 or also the twisting crowns 70A-70H are axially slaved or moved towards each other, since the twisting movement results in a shortening of the conductor end length. The twisting crowns 70A-70H have circumferentially distributed grooves 86a, 86i for receiving the conductor ends 34a-34h. Due to the nested structure of several such twisting crowns, the individual grooves 86a, 86i of the twisting crowns 70A-70H are closed outwardly as well as inwardly by the respective next twisting crown 70A-70H. For the innermost or the outermost twisting crown 70A, 70H, moreover, a ring can be used as a closing contour. The grooves 86a, 86i of the twisting crowns 70A-70H are alternately distributed over the entire circumference of the twisting crown 70A-70H. Each twisting crown 70A-70H may have internal as well as external grooves 86i, 86a, the positions of which are specifically adapted to the stator 50 to be processed. FIGS. 12 and 13 show an exemplary twisting crown 70B with internal grooves 86i and external grooves 86a.

The distribution of the grooves 86a, 86i on the twisting crown 70A-70H depends on the previously performed widening process. In the above description of the widening process, the two different positions a and i per position were discussed. For a conductor end at an outer position a, the associated twisting tool 70A-70H is awarded an outer groove 86a which is open to the outside, and for an inner layer, correspondingly, an inner groove 86i. Each conductor end of the stator 50 is awarded its own twisting crown groove 86a, 86i.

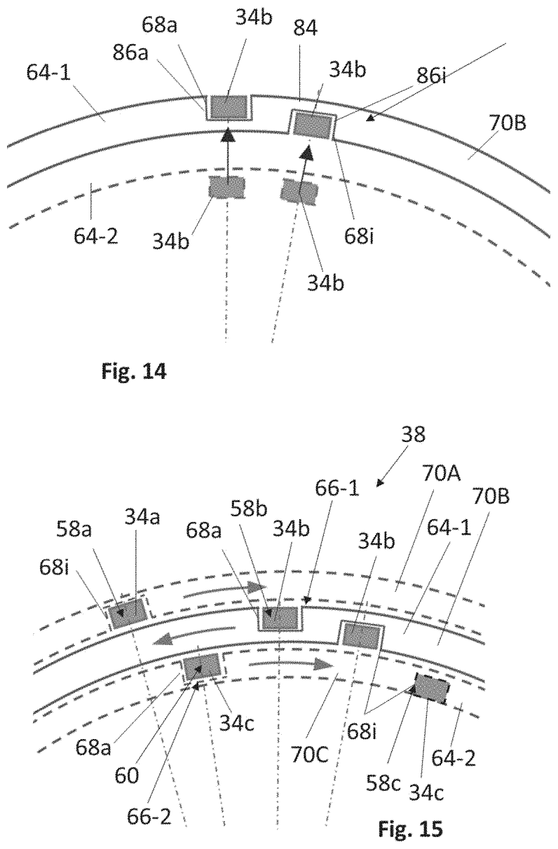

This is illustrated in FIG. 14 using the example of the twisting crown 70B, with only one inner groove 86i and one outer groove 86a shown for illustration purposes. Solid lines show the conductor ends 34b inserted into the inner groove 86i and outer groove 86a. The radial position of these conductor ends 34b before widening is shown by dashed lines.

The position of the conductor ends 34b is determined by the opening timing during the widening operation. For moving the grippers 62-1, 62-2, 62-3 in the radial direction with the conductor end gripped, it is defined at which position the conductor end should be located; in connection with this, it is defined when the gripper 621, 62-2, 62-3 should release the conductor end.

The release of the end of the conductor during the widening movement can take place with or without a stop.

For a defined stop, the axis (i.e. here the movement actuator of the respective gripper) is briefly stopped at the planned inner target position, the gripper 62-1, 62-2, 62-3 is opened and the end of the conductor is released. Since the widening process usually takes place from the inside to the outside, the inner position is reached first.

In contrast, when the end of the conductor is released during the movement, so called on-the-fly, the axis is not stopped. In this case, the conductor end is released when a defined position is reached during the travel of the widening axis.

The initial position of the grooves 86a, 86i of the twisting crowns 70A-70H before twisting corresponds to the final result of the conductor end positions after widening (see e.g. upper part of the TABLE 1 and FIG. 14), whereas the conductor end positions after twisting reflect the final switching scheme of the stator. Accordingly, the arrangement of the grooves 86a, 86i of the individual twisting crowns 70A-70H also follows the electrical wiring scheme of the stator 50 so that the mating conductor ends are interconnected.

An exemplary wiring diagram and at the same time the final result of the twisting operation is shown in the lower part of TABLE 1. During the twisting process, the twisting tools—here the twisting crowns 70A-70H—are rotated clockwise or counterclockwise by a defined angle, in this case by three groove distances (see direction of arrow). If the conductor ends are still separated from each other by six grooves at the start of the widening process, they subsequently form a pair after circumferential twisting in opposite directions. Two exemplary pair formations can be seen from the arrows in TABLE 1. The arrows show the movement of the conductor ends during the twisting process. By the position of the conductor ends, as described, it can be determined which receiving pocket 68a, 68i—one groove 86a, 86i of one of the twisting crowns 70A-70H—they will later dive in.

In FIG. 14, the principle of the inner position i of the inner grooves 86i and the outer position a of the outer grooves 86a is again shown schematically. The inner radial position i, at which the inner grooves 86i of the respective twisting crown 70B are located, is reached first during widening—here, for example, with the first gripper 62-1. As can be clearly seen, both positions a, i differ by the position of the annular wall 84 of the twisting crown 70B. This ultimately determines in which direction (outside or inside) the pair formation is to take place. For a purely single-grooved crown, the spacing of associated conductor ends is always a distance of at least one wall thickness. However, due to the principle of the inner and outer receiving pockets 68i, 68a, here formed by the inner grooves 86i and the outer grooves 86a, minor radial offsets between the widened conductor ends 34b can also be handled, and even more such offsets that occur with conductor ends at intermediate positions 60 compared with conductor ends at the regular positions 58c, 58d. Here, depending on the circuit diagram and the stator 50, it can be selected in advance whether inner receiving pockets 68i or outer receiving pockets of the respective bending units 64-1, 64-2 are located at the radial position of one of the regular positions or at the intermediate position.

By combining the different radial positions i, a of the inner grooves and outer grooves 86i, 86a on the twisting crown 70A-70H, the conductor ends 34a-34h to be interconnected can be placed as close to each other as possible. With the process described and the appropriate tools, even stators 50 with position jumps on the twisting side can be realized quickly and reliably in large series.

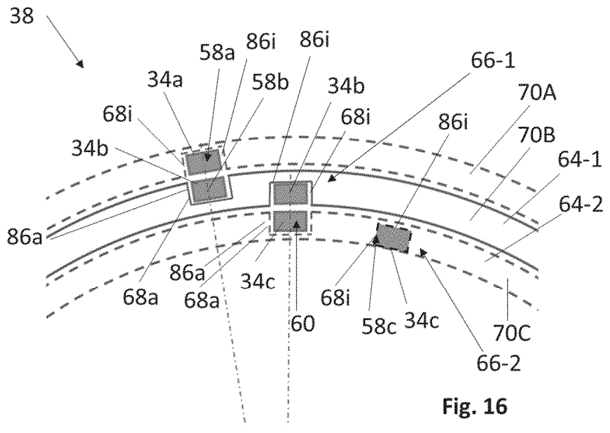

An exemplary twisting process for alternately grooved twisting crowns 70A-70C and the resulting conductor end pairings can be taken from FIGS. 15 and 16. FIG. 15 shows the position of the conductor ends of two conductor end pairs to be formed before twisting; and FIG. 16 shows the position after twisting.

Since the respective bending unit 64-1 arranged further out has radially inwardly open inner grooves 86i and the respective bending unit 64-2 arranged further in has radially outwardly open outer grooves 86a, pairs of conductor ends that are close to each other can be formed by aligning the inner grooves 86i with the outer grooves 86a. For example, one of the conductor end pairs shown in FIG. 16, e.g., the conductor end pair shown at the upper left, serves to connect two hairpins of the same ring 56a, while the other conductor end pair, e.g., the conductor end pair shown in the center, may serve to electrically connect the rings 56a, 56b, with at least one of the conductor ends of this conductor end pair being located at the at least one intermediate position 60.

If conductor ends are widened in pairs by means of the second gripper 62-1 or the third gripper 62-3 in step a), then the widened pair of conductor ends, which presents a correspondingly small spacing, is introduced for twisting into receiving grooves 68a, 68i of the adjacent twisting crowns 70A, 70B, 70C, which are open to one another and aligned with one another in the initial situation, as this is also shown in principle (albeit for the final situation) in FIG. 16. That conductor end of the pair of conductor ends which is located radially further inwards is inserted into an outer groove 86a of the twisting crown 70C located radially further inwards; and that conductor end of the pair of conductor ends which is situated radially further outwards is inserted into a correspondingly aligned inner groove 86i of the twisting crown 70B situated radially further outwards. The twisting crowns 70A-70C are then rotated, for example, to form new conductor end pairs to be welded together. It may also be that individual conductor ends remain after setting, which are then used for external connection of the coils.

Although the conductor end shaping device 14 has been described using the example of the manufacture of the stators 50 of the second category, it is clear that the same conductor end shaping device 14 can also be used for the manufacture of the stators of the first category merely by adapting the parameterization of the widening operation and the selection of the appropriate twisting crowns 70A-70H. Thus, a very flexible manufacturing process for very different stators 50 is feasible.

Thus, in order to enable a more flexible and process-safe manufacturing of very different hairpin stators (50), a conductor end shaping method and a conductor end shaping device (14) have been described, with which conductor ends (34a-34h) of hairpins (12) projecting from stator slots (20) are shaped for forming coil windings. In this process, the conductor ends (34a-34h) are formed in the radial direction by means of different widening tools (61-1, 61-2, 61-3) such as grippers (62-1, 62-2, 62-3), which allow gripping individually or in pairs, in such a way that a first part is situated at a first radial position (58b), a second part is situated at a second radial position (58c) and a third part is situated at at least one intermediate position (60) therebetween. Subsequently, the conductor ends (34a-34h) are shaped in the circumferential direction by means of twisting tools (64-1, 64-2; 70A-70H), wherein a twisting tool located further out has inwardly open inner receiving pockets (68a) and a twisting tool located further in has outwardly open outer receiving pockets (68i). In preferred embodiments, at least one of the twisting tools (64-1, 64-2; 70A-70H) has both inner and outer receiving pockets (68a, 68i). One of these sets of inner and outer receiving pockets is located at the at least one intermediate position to shape the third part of the conductor ends.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 stator manufacturing device
12 hairpin
14 conductor end shaping device
16 laminated core forming device
18 stator component
20 stator slot
22 slot insulation manufacturing device
24 slot insulation
26 hairpin manufacturing device
28 pre-positioning device
30 hairpin insertion device
32 winding head
34 conductor end
34a first conductor end
34b second conductor end
34c third conductor end
34d fourth conductor end
34e fifth conductor end
34f sixth conductor end
34g seventh conductor end
34h eighth conductor end
36 radial bending device
38 circumferential bending device
40 clamping and/or fixing device
42 conductor end cutting device
44 conductor end welding device
46 devices for electrical contacting and/or testing and/or casting, . . . .
48 winding head side
50 stator
52 twisting side
54 controller
56a first ring
56b second ring
56c third ring
56d fourth ring
58a primary position
58b secondary position
58c tertiary position
58d q quaternary position
58e quinary position
58f senary position
58g septenary position
58h octal position
60 intermediate position
61-1 first widening tool
61-2 second widening tool
61-3 third widening tool
62-1 first gripper
62-2 second gripper
62-3 third gripper
64-1 first bending unit
64-2 second bending unit
66-1 first annular arrangement of receiving pockets
66-2 second annular arrangement of receiving pockets
68a radially outer receiving pocket
68i radially inner receiving pocket
70A-70H twisting crowns for positions 58a-58h
72a first gripping jaw
72b second gripping jaw
74 connection bore
76 gripping area
78 rear shoulder
80 front shoulder
82-1 first gripping section
82-2 second gripping section
83 adjustable immersion depth
84 annular wall
86a outer grooves
86i inner grooves
e distance between conductor ends to be welded

Claimed is:

1. A conductor end shaping method for shaping conductor ends sticking out in an axial direction from an arrangement of stator slots of a stator component extending annularly about a central axis to form a stator of an electric machine, the conductor end shaping method comprising:
a) widening the conductor ends by bending the conductor ends in a radial direction with a plurality of widening tools of a radial bending device, such that the widening causes a first part of the conductor ends to be situated at a first radial position and a second part of the conductor ends to be situated at a second radial position; and
b) twisting the conductor ends by bending in a circumferential direction using a circumferential bending device, which has a first bending unit configured to rotate in a first direction of rotation and further has a first annular arrangement of receiving pockets, and a second bending unit configured to rotate in a second direction of rotation and is arranged concentrically with respect to the first bending unit and further has a second annular arrangement of receiving pockets, wherein step b) comprises
b1) inserting the first part of the conductor ends widened in step a) to the first radial position into the first arrangement of receiving pockets, inserting the second part of the conductor ends widened in step a) to the second radial position into the second arrangement of receiving pockets, and
b2) oppositely rotating the first bending unit and the second bending unit to bend the first part of the conductor ends and the second part of the conductor ends in opposite circumferential directions,
wherein step a) comprises:
a1) engaging at least one single conductor end by at least a first widening to bend the thus engaged at least one single conductor end individually in the radial direction, and engaging at least one pair of radially adjacent conductor ends jointly by at least a second widening tool, to jointly bend the pair of radially adjacent conductor ends in the radial direction, wherein step a1) is performed such that a third part of the conductor ends is situated at at least one intermediate radial position between the first and second radial positions,
wherein step b) further comprises
b0) providing, in a first arrangement, the first bending unit and second bending unit such that the bending unit that is located radially further out has radially inner receiving pockets that are open to a radially inner side, and, in a second arrangement, the bending unit that is located radially further in has radially outer receiving pockets that are open to a radially outer side, wherein
a part of the receiving pockets of the first arrangement is located at the first radial position and another part of the receiving pockets of the first arrangement is radially offset thereto and located at a radially intermediate position, or
a part of the receiving pockets of the second arrangement is located at the second radial position and another part of the receiving pockets of the second arrangement is radially offset thereto and located at a radially intermediate position, or
both, and
wherein step b1) further comprises
b1a) inserting conductor ends widened to the at least one radially intermediate position into a receiving pocket of the other part of the receiving pockets of the first or second arrangement, and inserting a radially inner conductor end of each pair of conductor ends bent together in step a1) into one of the radially outer receiving pockets and the radially outer conductor end of the pair into one of the radially inner receiving pockets.

2. The conductor end shaping method according to claim 1, wherein step a) further comprises at least one or more of the steps:
a0) providing a separate radial bending control data set for each individual conductor end to be radially bent or each pair of conductor ends to be jointly bent and individually controlling the respective widening tool by means of the radial bending control data set assigned to the conductor end to be bent;
a2) simultaneously using different widening tools from the plurality of widening tools selected from a group consisting of a single widening tool for engaging a single conductor end, a conductor end pair widening tool for engaging a pair of conductor ends, and a combination widening tool formed at different engagement sections for engaging a single conductor end and for engaging a pair of conductor ends;
a2a) simultaneously using, as widening tools, different grippers from a group of consisting of a single gripper for gripping a single conductor end, a conductor end pair gripper for gripping a pair of conductor ends, and a combination gripper formed at different gripping sections for gripping a single conductor end and for gripping a pair of conductor ends;
a3) simultaneously engaging, by said widening tools, a plurality of conductor ends sticking out at the same radial position from the stator slots and releasing individual or pairs of the thus engaged conductor ends after a differential movement in the radial direction so as to bend the first part to the first radial position, the third part to the at least one intermediate radial position and the second part to the second radial position.

3. The conductor end shaping method according to claim 2, wherein step a0) further comprises at least one or more of the steps:
a0a) generating the radial bending control data sets according to a winding scheme desired for the stator to be manufactured;
a0b) generating a master control data set for a conductor end or a pair of conductor ends to be equally bent to a group of conductor ends or pairs of conductor ends, and generating the further control data sets for the group of conductor ends or pairs of conductor ends to be equally bent while copying the master control data set;
a0c) parameterizing a target position and a radial bending movement for each conductor end to generate the radial bending control data set.

4. The conductor end shaping method according to claim 1, wherein step b0) further comprises at least one or more of the steps:
b01) providing, as the first bending unit, a first twisting crown having an annular wall, at an axial end of which the first arrangement of receiving pockets is formed, wherein radially inner receiving pockets are formed by inner grooves formed radially inwardly and open at the axial end, and radially outer receiving pockets are formed by outer grooves formed radially outwardly and open at the axial end;
b02) providing, as the second bending unit, a second twisting crown having an annular wall, at an axial end of which the second arrangement of receiving pockets is formed, wherein radially inner receiving pockets are formed by inner grooves formed radially inwardly and open at the axial end and radially outer receiving pockets are formed by outer grooves formed radially outwardly and open at the axial end.

5. A conductor end shaping device for shaping conductor ends sticking out in an axial direction from an arrangement of stator slots of a stator component extending annularly around a central axis to form a stator of an electric machine, the device comprising:
a radial bending device for widening the conductor ends and including a plurality of widening tools configured to bend the conductor ends in the radial direction such that, after bending, a first part of the conductor ends is situated at a first radial position and a second part of the conductor ends is situated at a second radial position,
a circumferential bending device for twisting the conductor ends by bending in a circumferential direction, the circumferential bending device comprising a first bending unit configured to be rotated in a first direction of rotation and having a first annular arrangement of receiving pockets, and a second bending unit arranged concentrically thereto and configured to be rotated in the second direction of rotation and having a second annular arrangement of receiving pockets,
and a controller adapted to control the conductor end shaping device to
a) widen the conductor ends by bending the conductor ends in a radial direction with the plurality of widening tools of the radial bending device such that the widening causes the first part of the conductor ends to be situated at the first radial position and the second part of the conductor ends to be situated at the second radial position, and
b) twist the conductor ends by bending in the circumferential direction with the circumferential bending device by
b1) inserting the first part of conductor ends widened to the first radial position in step a) into a first arrangement of receiving pockets, inserting the second part of conductor ends to the second radial position in step a) into a second arrangement of receiving pockets, and
b2) oppositely rotating said first and second bending units to bend said first part of conductor ends and said second part of conductor ends in opposite circumferential directions,
wherein
of the first and second bending devices, in the first arrangement, the bending unit that is located radially further out has radially inner receiving pockets open to a radially inner side, and the bending unit that is located radially further in has radially outer receiving pockets open to a radially outer side, wherein a part of the receiving pockets of the first arrangement is located at the first radial position and another part of the receiving pockets of the first arrangement is radially offset thereto and located at a radially intermediate position, or
a part of the receiving pockets in the second arrangement is located at the second radial position and another part of the receiving pockets of the second arrangement is radially offset thereto and located at a radially intermediate position, or
both,
wherein the controller is further configured, during the widening according to a), to control the conductor end shaping device to
a1) engage at least one individual conductor end by at least one first widening tool in order to bend the conductor end thus engaged individually in the radial direction, and jointly engage at least one pair of radially adjacent conductor ends by at least one second widening tool, to jointly bend said pair of radially adjacent conductor ends in the radial direction, wherein said controller is adapted to perform control of said widening tools such that a third part of said conductor ends is situated at at least one intermediate radial position between said first and second radial positions
and wherein the controller is further adapted to control the conductor end shaping device during insertion according to step b 1) for
b1a) inserting conductor ends widened to the at least one intermediate radial position into a receiving pocket of the other part of the first or second arrangement and inserting a radially inner conductor end of each pair of the conductor ends jointly bent in step a1) into one of the radially outer receiving pockets and the radially outer conductor end of the pair into one of the radially inner receiving pockets.

6. The conductor end shaping device according to claim 5, wherein the controller is further configured to control the widening tools of the radial bending device individually on the basis of individual dedicated radial bending control data sets for each individual conductor end to be radially bent or for each pair of conductor ends to be bent together.

7. The conductor end forming device according to claim 5, wherein the radial bending device
includes different widening tools from the plurality of widening tools selected from a group consisting of a single widening tool for engaging a single conductor end, a conductor end pair widening tool for engaging a pair of conductor ends, and a combination widening tool formed at different engagement sections for engaging a single conductor end and for engaging a pair of conductor ends; or
includes, as widening tools, different grippers from a group of grippers consisting of a single gripper for gripping a single conductor end, a conductor end pair gripper for gripping a pair of conductor ends, and a combination gripper formed at different gripping sections for gripping a single conductor end and for gripping a pair of conductor ends; or
includes grippers having a first gripping jaw and a second gripping jaw configured to move towards each other for gripping and away from each other for releasing, wherein a receiving groove for the conductor end or ends to be gripped is formed between two shoulders on at least one of the gripping jaws, which groove is configured to surround a single conductor end in the case of a single gripper and a pair of conductor ends in the case of conductor end pair grippers; or
includes a combination gripper having different gripping sections, one of which is formed for gripping a single conductor end and another of which is formed for gripping a pair of conductor ends, or
any combination thereof.

8. The conductor end shaping device according to claim 5, wherein the controller is further configured to control the radial bending device to
a3) simultaneously engage by said widening tools a plurality of conductor ends sticking out at the same radial position from the stator slots and releasing individual or pairs of the conductor ends thus engaged after a differential movement in radial direction, so as to bend the first part to the first radial position, the third part to the at least one intermediate radial position and the second part to the second radial position.

9. The conductor end shaping device according to claim 5, wherein the circumferential bending means comprises
as the first bending unit a first twisting crown having an annular wall at an axial end of which the first arrangement of receiving pockets is formed, wherein radially inner receiving pockets are formed by inner grooves formed radially inwardly and open at the axial end and radially outer receiving pockets are formed by outer grooves formed radially outwardly and open at the axial end; or
as the second bending unit a second twisting crown having an annular wall at an axial end of which the second arrangement of receiving pockets is formed, wherein radially inner receiving pockets are formed by inner grooves formed radially inwardly and open at the axial end and radially outer receiving pockets are formed by outer grooves formed radially outwardly and open at the axial end; or
both.

10. A non-transitory computer readable medium storing instructions for performing the conductor end shaping method according to claim 1.
